(19) United States
(12) Patent Application Publication
(10) Pub. No.: US 2026/0263999 A1
(43) Pub. Date: Sep. 10, 2026

(54) CARBON DIOXIDE SEPARATION DEVICE

(71) Applicant: HONDA MOTOR CO., LTD., Tokyo (JP)

(72) Inventor: Takuma Arai, Wako-shi (JP)

(21) Appl. No.: 19/542,949

(22) Filed: Feb. 18, 2026

(30) Foreign Application Priority Data
Mar. 5, 2025 (JP) 2025-034328

(51) Int. Cl. B01D 53/22

(52) U.S. Cl. CPC B01D 53/226; B01D 53/229; B01D 2257/504

(57) ABSTRACT

A carbon dioxide separation device includes a first membrane separator configured to introduce a raw material gas containing carbon dioxide, a combustor provided downstream of the first membrane separator and configured to combust a first non-permeate gas, a second membrane separator provided downstream of the combustor, a compressor configured to supply a combustion gas to the second membrane separator, and at least one third membrane separator provided downstream of the second membrane separator.

### CROSS-REFERENCE TO RELATED APPLICATION

Priority is claimed on Japanese Patent Application No. 2025-034328, filed Mar. 05, 2025, the content of which is incorporated herein by reference.

### BACKGROUND OF THE INVENTION

### Field of the Invention

The present invention relates to a carbon dioxide separation device.

### Description of Related Art

For example, as a technique for separating and recovering carbon dioxide (CO₂) from natural gas containing methane (CH₄), a carbon dioxide separation device including a raw material gas introduction line configured to introduce a raw material gas containing carbon dioxide, a first membrane separator connected to an end portion of the raw material gas introduction line and configured to membrane-separate carbon dioxide from the raw material gas, a first permeate gas discharge line configured to discharge a first permeate gas permeated by membrane separation with the first membrane separator, a first non-permeate gas discharge line configured to discharge a first non-permeate gas not permeated by membrane separation with the first membrane separator, a second membrane separator provided downstream of the first membrane separator and configured to membrane-separate carbon dioxide from the first non-permeate gas, a second permeate gas discharge line configured to discharge a second permeate gas permeated by membrane separation with the second membrane separator, and a second permeate gas returning line branched from a part of the second permeate gas discharge line and configured to return the second permeate gas to the raw material gas or the first non-permeate gas is known (refer to, for example, Japanese Unexamined Patent Application, First Publication No. 2016-93767).

### SUMMARY OF THE INVENTION

In a system for recovering carbon dioxide that is discharged from a combustor, when a carbon dioxide recovery system is assumed to be mounted downstream of the combustor, there is a case where a pressure downstream of the combustor (back pressure) increases due to an influence of a pressure loss or the like and abnormal combustion, an accidental fire, or the like occurs in the combustor, which may cause a problem. Therefore, there is a demand for a process design that prevents the back pressure of the combustor from being increased too much.

An aspect of the present invention provides a carbon dioxide separation device capable of curbing abnormal combustion or an accidental fire in a combustor and, furthermore, also improving the performance of the carbon dioxide separation device itself. The aspect of the present invention contributes to energy efficiency improvement.

The present invention has the following aspects.

[1] A carbon dioxide separation device including:

a raw material gas introduction line configured to introduce a raw material gas containing carbon dioxide;

a first membrane separator connected to an end portion of the raw material gas introduction line and configured to introduce the raw material gas;

a first permeate gas discharge line configured to discharge a first permeate gas permeated by membrane separation with the first membrane separator;

a first non-permeate gas discharge line configured to discharge a first non-permeate gas not permeated by membrane separation with the first membrane separator;

a combustor provided downstream of the first membrane separator and configured to combust the first permeate gas;

a combustion gas discharge line connected to the combustor and configured to discharge a combustion gas obtained by combusting the first permeate gas with the combustor;

a second membrane separator provided downstream of the combustor and connected to the combustion gas discharge line;

a compressor provided in a middle of the combustion gas discharge line and configured to supply a combustion gas to the second membrane separator;

a second permeate gas discharge line configured to discharge a second permeate gas permeated by membrane separation with the second membrane separator; and

a second non-permeate gas discharge line configured to discharge a second non-permeate gas not permeated by membrane separation with the second membrane separator and supply the second non-permeate gas to the first membrane separator.

According to the aspect, the compressor is disposed downstream of the combustor, whereby it is possible to anticipate a synergistic effect of curbing abnormal combustion or accidental fire in the combustor and, furthermore, also improving the performance of the carbon dioxide separation device itself.

[2] The carbon dioxide separation device according to [1], further including:

a first vacuum pump provided in a middle of the second permeate gas discharge line and configured to supply the second permeate gas to the second membrane separator;

at least one third membrane separator provided downstream of the second membrane separator and connected to the second permeate gas discharge line;

a third permeate gas discharge line configured to discharge a third permeate gas permeated by membrane separation with the third membrane separator;

a third non-permeate gas discharge line configured to discharge a third non-permeate gas not permeated by membrane separation with the third membrane separator and supply the third non-permeate gas to the combustion gas discharge line; and

a second vacuum pump provided in a middle of the third permeate gas discharge line.

According to the aspect, the compressor is disposed downstream of the combustor, whereby it is possible to anticipate a synergistic effect of curbing abnormal combustion or accidental fire in the combustor and, furthermore, also improving the performance of the carbon dioxide separation device itself.

[3] The carbon dioxide separation device according to [1], in which in a case where a carbon monoxide concentration downstream of the combustor is a predetermined value or lower and an oxygen concentration upstream of the combustor is lower than a predetermined value, a pressure of the combustion gas that is supplied to the second membrane separator is decreased with the compressor.

According to the aspect, it is possible to curb a negative impact on the combustor by an increase in flame temperature and to maintain the oxygen concentration constant.

[4] The carbon dioxide separation device according to [1], in which in a case where an oxygen concentration upstream of the combustor is a predetermined value or higher, a pressure of the combustion gas that is supplied to the second membrane separator is increased with the compressor.

According to the aspect, it is possible to curb a negative impact on the combustor by an increase in flame temperature and to maintain the oxygen concentration constant.

According to the aspects of the present invention, it is possible to provide a carbon dioxide separation device capable of curbing abnormal combustion or an accidental fire in a combustor and, furthermore, also improving the performance of the carbon dioxide separation device itself.

### BRIEF DESCRIPTION OF THE DRAWINGS

FIG. 1 is a schematic view illustrating a carbon dioxide separation device of a first embodiment of the present invention.

FIG. 2 is a flowchart of a carbon dioxide separation method in which the carbon dioxide separation device of the first embodiment of the present invention is used.

FIG. 3 is a schematic view illustrating a carbon dioxide separation device of a second embodiment of the present invention.

FIG. 4 is a flowchart of a carbon dioxide separation method in which the carbon dioxide separation device of the second embodiment of the present invention is used.

FIG. 5 is a schematic view illustrating a carbon dioxide separation device of a third embodiment of the present invention.

FIG. 6 is a schematic view illustrating a carbon dioxide separation device of a fourth embodiment of the present invention.

### DETAILED DESCRIPTION OF THE INVENTION

Hereinafter, embodiments of the present invention will be described.

### Carbon dioxide separation device

### First embodiment

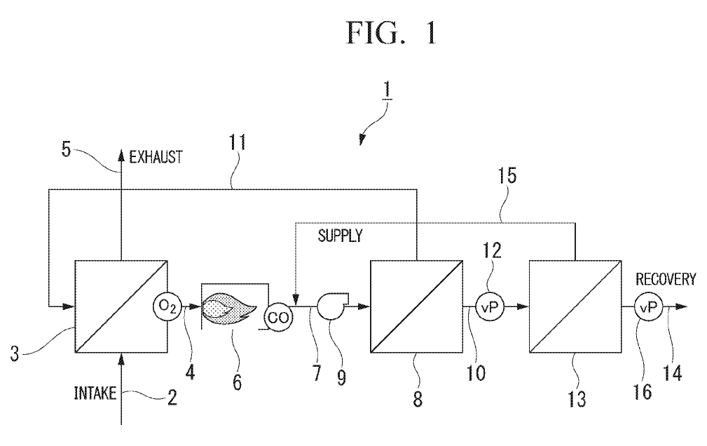

FIG. 1 is a schematic view illustrating a carbon dioxide separation device of the present embodiment.

As illustrated in FIG. 1, a carbon dioxide separation device 1 of the present embodiment includes a first raw material gas introduction line 2, a first membrane separator 3, a first permeate gas discharge line 4, a first non-permeate gas discharge line 5, a combustor 6, a combustion gas discharge line 7, a second membrane separator 8, a compressor 9, a second permeate gas discharge line 10, and a second non-permeate gas discharge line 11. In addition, the carbon dioxide separation device 1 of the present embodiment preferably includes a first vacuum pump 12, a third membrane separator 13, a third permeate gas discharge line 14, a third non-permeate gas discharge line 15, and a second vacuum pump 16.

The raw material gas introduction line (first raw material gas introduction line) 2 is intended to introduce a raw material gas containing carbon dioxide into the first membrane separator 3.

The first membrane separator 3 is connected to the end portion of the first raw material gas introduction line 2 and is intended to introduce the raw material gas. In addition, the first membrane separator 3 is connected to the second non-permeate gas discharge line 11 and is intended to membrane-separate a second non-permeate gas supplied from the second membrane separator 8 through the second non-permeate gas discharge line 11. As the first membrane separator 3, a carbon dioxide separator including an ordinary carbon dioxide separation membrane can be used.

The first permeate gas discharge line 4 is connected to the first membrane separator 3 and is intended to discharge a first permeate gas permeated by membrane separation with the first membrane separator 3 from the first membrane separator 3.

The first non-permeate gas discharge line 5 is connected to the first membrane separator 3 and is intended to discharge a first non-permeate gas not permeated by membrane separation with the first membrane separator 3.

The combustor 6 is provided downstream of the first membrane separator 3, is connected to the first non-permeate gas discharge line 5, and is intended to combust the first permeate gas.

The combustion gas discharge line 7 is connected to the combustor 6 and is intended to discharge a combustion gas obtained by combusting the first permeate gas with the combustor 6 downstream of the combustor 6.

The second membrane separator 8 is provided downstream of the combustor 6 and is connected to the combustion gas discharge line 7. In addition, the second membrane separator 8 is intended to membrane-separate the combustion gas supplied from the combustor 6. As the second membrane separator 8, a carbon dioxide separator including an ordinary carbon dioxide separation membrane can be used.

The compressor 9 is provided in the middle of the combustion gas discharge line 7 and is intended to supply the combustion gas to the second membrane separator 8.

The second permeate gas discharge line 10 is connected to the second membrane separator 8 and is intended to discharge a second permeate gas permeated by membrane separation with the second membrane separator 8.

The second non-permeate gas discharge line 11 is connected to the second membrane separator 8 and is intended to discharge a second non-permeate gas not permeated by membrane separation with the second membrane separator 8 and supply the second non-permeate gas to the first membrane separator 3.

The first vacuum pump 12 is provided in the middle of the second permeate gas discharge line 10 and is intended to supply the second permeate gas to the second membrane separator 8.

The third membrane separator 13 is provided downstream of the second membrane separator 8 and is connected to the second permeate gas discharge line 10. In addition, the third membrane separator 13 is intended to membrane-separate the second permeate gas supplied from the second membrane separator 8. As the third membrane separator 13, a carbon dioxide separator including an ordinary carbon dioxide separation membrane can be used.

The third permeate gas discharge line 14 is connected to the third membrane separator 13 and is intended to discharge a third permeate gas permeated by membrane separation with the third membrane separator 13 from the third membrane separator 13.

The third non-permeate gas discharge line 15 is connected to the third membrane separator 13 and is intended to discharge a third non-permeate gas not permeated by membrane separation with the third membrane separator 13 and supply the third non-permeate gas to the combustion gas discharge line 7.

The second vacuum pump 16 is provided in the middle of the third permeate gas discharge line 14 and is intended to discharge the third permeate gas from the third membrane separator 13.

A control logic of the carbon dioxide separation device of the present embodiment will be described.

In a case where a carbon monoxide concentration downstream of the combustor 6 is a predetermined value or lower and the oxygen concentration upstream of the combustor 6 is lower than a predetermined value, the pressure of the combustion gas that is supplied to the second membrane separator 8 is decreased by operating the compressor 9. This makes it possible to curb a negative impact on the combustor 6 by an increase in flame temperature and to maintain the oxygen concentration constant.

In addition, in a case where the oxygen concentration upstream of the combustor 6 is the predetermined value or higher, the pressure of the combustion gas that is supplied to the second membrane separator 8 is increased by operating the compressor 9. This makes it possible to curb a negative impact on the combustor 6 by an increase in flame temperature and to maintain the oxygen concentration constant.

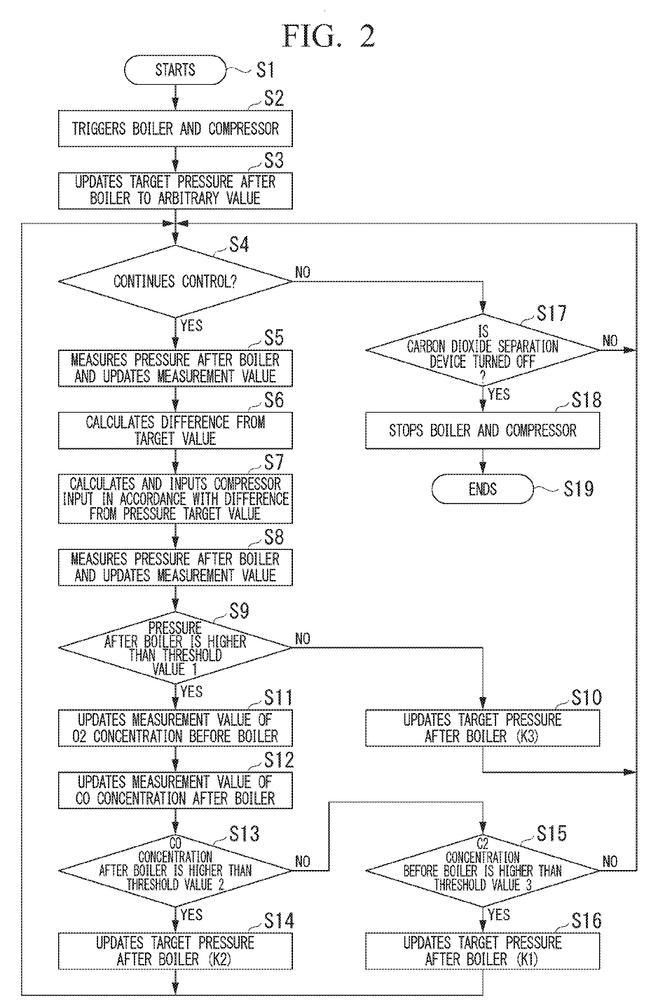

FIG. 2 is a flowchart of a carbon dioxide separation method in which the carbon dioxide separation device of the present embodiment is used.

The carbon dioxide separation device 1 is turned on to operate the carbon dioxide separation device 1 (step: S1). Then, the combustor 6 and the compressor 9 are triggered (step: S2).

Next, a target value of the pressure of the combustion gas that is supplied to the second membrane separator 8 downstream of the combustor 6 is set to an arbitrary value (step: S3).

Whether or not to continue the control of the pressure of the combustion gas that is supplied to the second membrane separator 8 is confirmed (step: S4). In the case of continuing the control of the pressure of the combustion gas that is supplied to the second membrane separator 8, the pressure of the combustion gas that is supplied to the second membrane separator 8 is measured, and the target value of the pressure of the combustion gas that is supplied to the second membrane separator 8 is updated (step: S5).

Next, a difference between the measurement value of the pressure of the combustion gas that is supplied to the second membrane separator 8 and the target value of the pressure of the combustion gas that is supplied to the second membrane separator 8 is calculated (step: S6). The pressure of the combustion gas that is supplied to the second membrane separator 8 in accordance with the difference is calculated, and the compressor 9 is controlled to obtain the calculated pressure (step : S7).

Next, the pressure of the combustion gas that is supplied to the second membrane separator 8 is measured, and the target value of the pressure of the combustion gas that is supplied to the second membrane separator 8 is updated (step: S8).

Whether or not the pressure of the combustion gas that is supplied to the second membrane separator 8 downstream of the combustor 6 is higher than a threshold value 1 is confirmed (step: S9).

In a case where the pressure of the combustion gas that is supplied to the second membrane separator 8 downstream of the combustor 6 is lower than the threshold value 1, the target value of the pressure of the combustion gas that is supplied to the second membrane separator 8 downstream of the combustor 6 is updated (K3), and the process is returned to the step: S4 (step: S10).

On the other hand, in a case where the pressure of the combustion gas that is supplied to the second membrane separator 8 downstream of the combustor 6 is higher than the threshold value 1, the oxygen concentration is measured upstream of the combustor 6, and the concentration of oxygen that is supplied to the combustor 6 is updated (step: S11).

Next, the carbon monoxide concentration is measured downstream of the combustor 6, and the concentration of carbon monoxide that is discharged from the combustor 6 is updated (step: S12).

Whether or not the pressure of the combustion gas that is supplied to the second membrane separator 8 downstream of the combustor 6 is higher than a threshold value 2 is confirmed (step: S13).

In a case where the pressure of the combustion gas that is supplied to the second membrane separator 8 downstream of the combustor 6 is higher than the threshold value 2, the target value of the pressure of the combustion gas that is supplied to the second membrane separator 8 downstream of the combustor 6 is updated (K2), and the process is returned to the step: S4 (step: S14).

In a case where the pressure of the combustion gas that is supplied to the second membrane separator 8 downstream of the combustor 6 is lower than the threshold value 2, whether or not the concentration of oxygen that is supplied to the second membrane separator 8 upstream of the combustor 6 is higher than a threshold value 3 is confirmed (step: S15). In a case where the concentration of oxygen that is supplied to the second membrane separator 8 upstream of the combustor 6 is higher than the threshold value 3, the target value of the pressure of the combustion gas that is supplied to the second membrane separator 8 downstream of the combustor 6 is updated (K1), and the process is returned to the step: S4 (step: S16).

On the other hand, in a case where the concentration of oxygen that is supplied to the second membrane separator 8 upstream of the combustor 6 is lower than the threshold value 3, the process is returned to the step: S4.

In the step: S4, in the case of not continuing the control of the pressure of the combustion gas that is supplied to the second membrane separator 8, whether or not to turn off the carbon dioxide separation device 1 is determined (step: S17). In a case where the carbon dioxide separation device 1 is not turned off, the process is returned to the step: S4.

In a case where the carbon dioxide separation device 1 is turned off, the combustor 6 and the compressor 9 are stopped (step: S18), and the operation of the carbon dioxide separation device 1 is stopped (step: S19).

According to the carbon dioxide separation device 1 of the present embodiment, the compressor 9 is disposed downstream of the combustor 6, whereby it is possible to anticipate a synergistic effect of curbing abnormal combustion or an accidental fire in the combustor 6 and, furthermore, also improving the performance of the carbon dioxide separation device 1 itself.

### Second embodiment

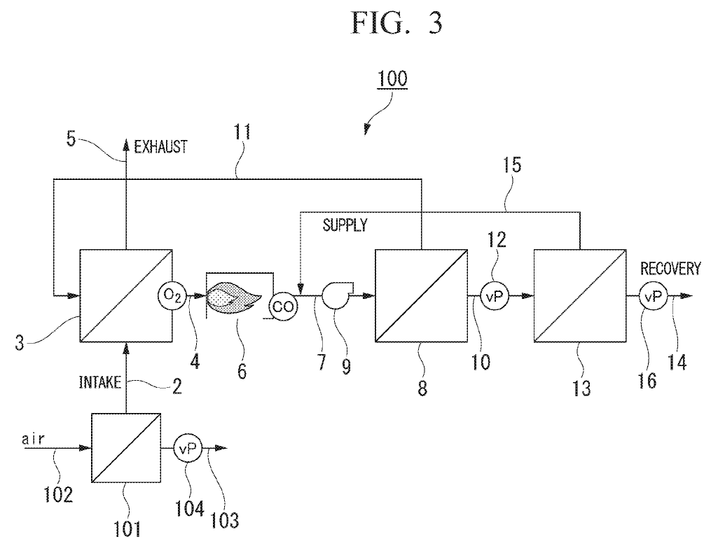

FIG. 3 is a schematic view illustrating a carbon dioxide separation device of the present embodiment. In FIG. 3, the same configuration as the configuration illustrated in FIG. 1 will be given the same reference sign and will not be described again.

As illustrated in FIG. 3, a carbon dioxide separation device 100 of the present embodiment includes, in addition to the above-described carbon dioxide separation device 1, a fourth membrane separator 101, a second raw material gas introduction line 102, a fourth permeate gas discharge line 103, and a third vacuum pump 104.

The fourth membrane separator 101 is connected to the end portion of the second raw material gas introduction line 102 and is intended to introduce a raw material gas. In addition, the fourth membrane separator 101 is connected to the end portion of the first raw material gas introduction line 2 and is intended to separate nitrogen in the raw material gas in advance and supply the raw material gas from which nitrogen has been removed to the first membrane separator 3 through the first raw material gas introduction line 2. Nitrogen in the raw material gas is separated in advance, whereby the recovery rate of carbon dioxide improves.

The fourth permeate gas discharge line 103 is connected to the fourth membrane separator 101 and is intended to discharge a fourth permeate gas (nitrogen) permeated by membrane separation with the fourth membrane separator 101 from the fourth membrane separator 101.

The third vacuum pump 104 is provided in the middle of the fourth permeate gas discharge line 103 and is intended to discharge the fourth permeate gas (nitrogen) from the fourth membrane separator 101.

A control logic of the carbon dioxide separation device of the present embodiment will be described.

In a case where the carbon dioxide concentration downstream of the combustor 6 is a predetermined value or lower and the oxygen concentration upstream of the combustor 6 is lower than a predetermined value, the pressure of the combustion gas that is supplied to the second membrane separator 8 is decreased by operating the compressor 9. This makes it possible to curb a negative impact on the combustor 6 by an increase in flame temperature and to maintain the oxygen concentration constant.

In addition, in a case where the oxygen concentration upstream of the combustor 6 is the predetermined value or higher, the pressure of the combustion gas that is supplied to the second membrane separator 8 is increased by operating the compressor 9. This makes it possible to curb a negative impact on the combustor 6 by an increase in flame temperature and to maintain the oxygen concentration constant.

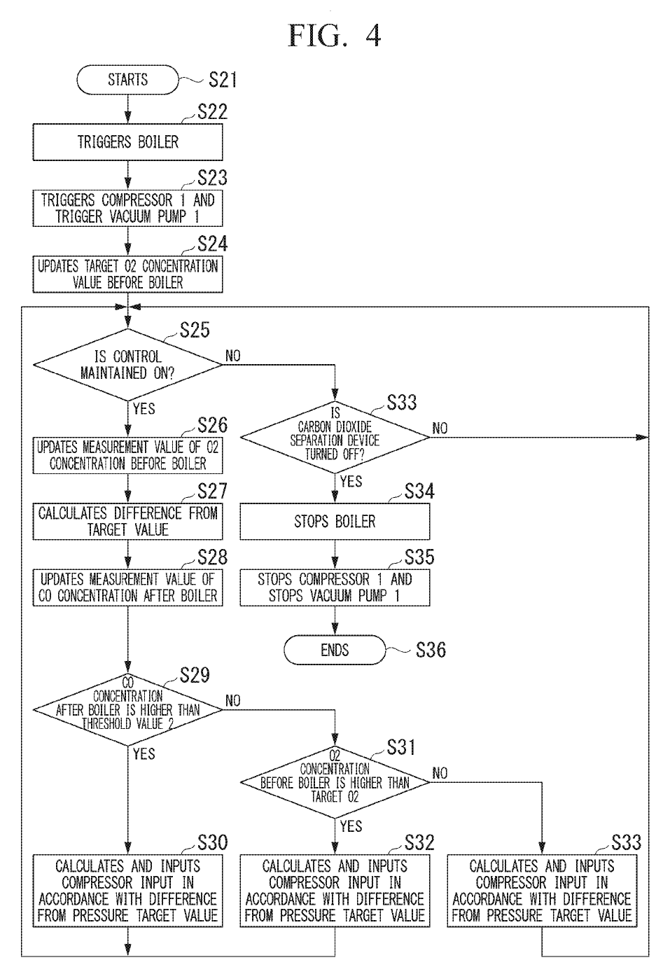

FIG. 4 is a flowchart of a carbon dioxide separation method in which the carbon dioxide separation device of the present embodiment is used.

The carbon dioxide separation device 100 is turned on to operate the carbon dioxide separation device 100 (step: S21). Then, the combustor 6 is triggered (step: S22).

Next, the compressor 9 and the third vacuum pump 104 are triggered (step: S23).

Next, the oxygen concentration is measured upstream of the combustor 6, and the concentration of oxygen that is supplied to the combustor 6 is updated (step: S24).

Whether or not to continue the control of the pressure of oxygen that is supplied to the combustor 6 is confirmed (step: S25). In the case of continuing the control of the pressure of oxygen that is supplied to the combustor 6, the oxygen concentration is measured upstream of the combustor 6, and the concentration of oxygen that is supplied to the combustor 6 is updated (step: S26).

Next, a difference between the measurement value of the pressure of oxygen that is supplied to the combustor 6 and the target value of the pressure of oxygen that is supplied to the combustor 6 is calculated (step: S27).

Next, the concentration of carbon monoxide that is supplied to the second membrane separator 8 is measured downstream of the combustor 6, and the concentration of carbon monoxide that is supplied to the second membrane separator 8 is updated (step: S28).

Whether or not the concentration of carbon monoxide that is supplied to the second membrane separator 8 downstream of the combustor 6 is higher than a threshold value 2 is confirmed (step: S29).

In a case where the concentration of carbon monoxide that is supplied to the second membrane separator 8 is higher than the threshold value 2, a difference between the measurement value of the pressure of carbon monoxide that is supplied to the second membrane separator 8 and the target value of the pressure of carbon monoxide that is supplied to the second membrane separator 8 is calculated, the pressure of carbon monoxide that is supplied to the second membrane separator 8 in accordance with the difference is calculated, the compressor 9 is controlled to obtain the calculated pressure, and the process is returned to the step: S25 (step : S30).

In a case where the concentration of carbon monoxide that is supplied to the second membrane separator 8 is lower than the threshold value 2, the concentration of oxygen that is supplied to the combustor 6 upstream of the combustor 6 is measured, and whether or not the concentration of oxygen that is supplied to the combustor 6 is lower than the target value is confirmed (step: S31).

In a case where the concentration of oxygen that is supplied to the combustor 6 is higher than the target value, a difference between the measurement value of the pressure of carbon monoxide that is supplied to the second membrane separator 8 and the target value of the pressure of carbon monoxide that is supplied to the second membrane separator 8 is calculated, the pressure of carbon monoxide that is supplied to the second membrane separator 8 in accordance with the difference is calculated, the compressor 9 is controlled to obtain the calculated pressure, and the process is returned to the step: S25 (step : S32).

In a case where the concentration of oxygen that is supplied to the combustor 6 is lower than the target value, a difference between the measurement value of the pressure of carbon monoxide that is supplied to the second membrane separator 8 and the target value of the pressure of carbon monoxide that is supplied to the second membrane separator 8 is calculated, the pressure of carbon monoxide that is supplied to the second membrane separator 8 in accordance with the difference is calculated, the compressor 9 is controlled to obtain the calculated pressure, and the process is returned to the step: S25.

In the step: S25, in the case of not continuing the control of the pressure of oxygen that is supplied to the second membrane separator 8, whether or not to turn off the carbon dioxide separation device 100 is determined (step: S33). In a case where the carbon dioxide separation device 100 is not turned off, the process is returned to the step: S25.

In a case where the carbon dioxide separation device 100 is turned off, the combustor 6 is stopped (step: S34), the compressor 9 and the third vacuum pump 104 are stopped (step: S35), and the operation of the carbon dioxide separation device 100 is stopped (step: S36).

According to the carbon dioxide separation device 100 of the present embodiment, nitrogen in the raw material gas is separated in advance with the fourth membrane separator 101, whereby the recovery rate of carbon dioxide improves.

### Third embodiment

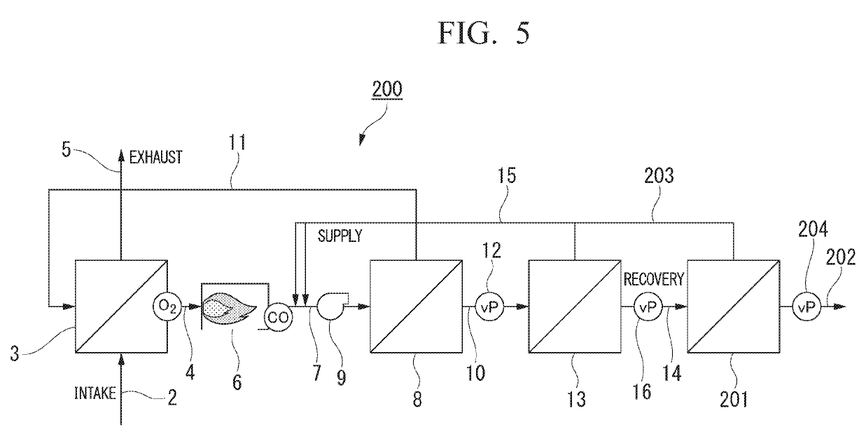

FIG. 5 is a schematic view illustrating a carbon dioxide separation device of the present embodiment. In FIG. 5, the same configuration as the configuration illustrated in FIG. 1 will be given the same reference sign and will not be described again.

As illustrated in FIG. 5, a carbon dioxide separation device 200 of the present embodiment includes, in addition to the above-described carbon dioxide separation device 1, a fifth membrane separator 201, a fifth permeate gas discharge line 202, a fifth non-permeate gas discharge line 203, and a fourth vacuum pump 204.

The fifth membrane separator 201 is provided downstream of the third membrane separator 13 and is connected to the third permeate gas discharge line 14. In addition, the fifth membrane separator 201 is intended to membrane-separate a third permeate gas supplied from the third membrane separator 13. As the fifth membrane separator 201, a carbon dioxide separator including an ordinary carbon dioxide separation membrane can be used.

The fifth permeate gas discharge line 202 is connected to the fifth membrane separator 201 and is intended to discharge a fifth permeate gas permeated by membrane separation with the fifth membrane separator 201 from the fifth membrane separator 201.

The fifth non-permeate gas discharge line 203 is connected to the fifth membrane separator 201 and is intended to discharge a fifth non-permeate gas not permeated by membrane separation with the fifth membrane separator 201 and supply the fifth non-permeate gas to the combustion gas discharge line 7.

The fourth vacuum pump 204 is provided in the middle of the fifth permeate gas discharge line 202 and is intended to discharge the fifth permeate gas from the fifth membrane separator 201.

According to the carbon dioxide separation device 200 of the present embodiment, the fifth membrane separator 201 is provided, whereby it is possible to further enhance the recovery rate of carbon dioxide.

### Fourth embodiment

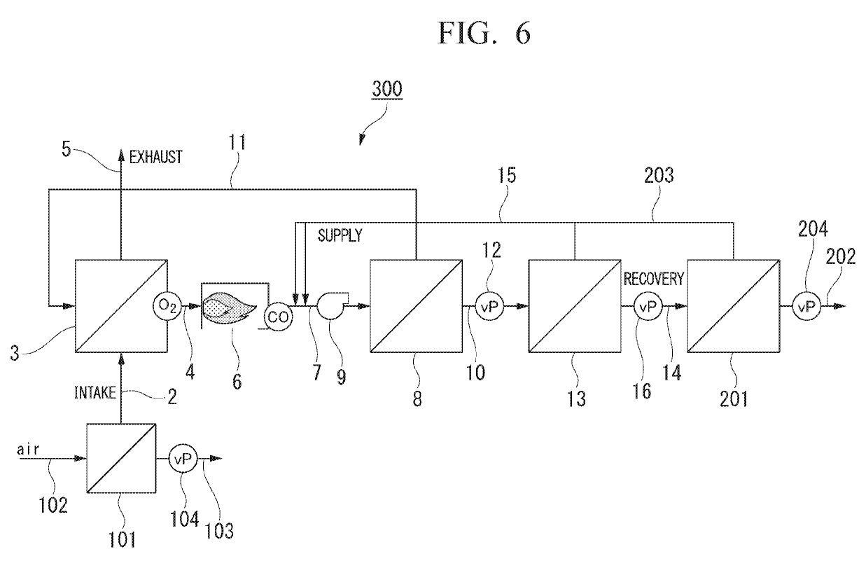

FIG. 6 is a schematic view illustrating a carbon dioxide separation device of the present embodiment. In FIG. 6, the same configuration as the configuration illustrated in FIGS. 1, 3, and 5 will be given the same reference sign and will not be described again.

As illustrated in FIG. 6, a carbon dioxide separation device 300 of the present embodiment includes, in addition to the above-described carbon dioxide separation device 200, the fourth membrane separator 101, the second raw material gas introduction line 102, the fourth permeate gas discharge line 103, and the third vacuum pump 104.

According to the carbon dioxide separation device 300 of the present embodiment, the fourth membrane separator 101 and the fifth membrane separator 201 are provided, whereby it is possible to separate nitrogen in the raw material gas in advance and to further enhance the recovery rate of carbon dioxide.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A carbon dioxide separation device comprising:
a raw material gas introduction line configured to introduce a raw material gas containing carbon dioxide;
a first membrane separator connected to an end portion of the raw material gas introduction line and configured to introduce the raw material gas;
a first permeate gas discharge line configured to discharge a first permeate gas permeated by membrane separation with the first membrane separator;
a first non-permeate gas discharge line configured to discharge a first non-permeate gas not permeated by membrane separation with the first membrane separator;
a combustor provided downstream of the first membrane separator and configured to combust the first permeate gas;
a combustion gas discharge line connected to the combustor and configured to discharge a combustion gas obtained by combusting the first permeate gas with the combustor;
a second membrane separator provided downstream of the combustor and connected to the combustion gas discharge line;
a compressor provided in a middle of the combustion gas discharge line and configured to supply the combustion gas to the second membrane separator;
a second permeate gas discharge line configured to discharge a second permeate gas permeated by membrane separation with the second membrane separator; and
a second non-permeate gas discharge line configured to discharge a second non-permeate gas not permeated by membrane separation with the second membrane separator and supply the second non-permeate gas to the first membrane separator.

2. The carbon dioxide separation device according to claim 1, further comprising:
a first vacuum pump provided in a middle of the second permeate gas discharge line and configured to supply the second permeate gas to the second membrane separator;
at least one third membrane separator provided downstream of the second membrane separator and connected to the second permeate gas discharge line;
a third permeate gas discharge line configured to discharge a third permeate gas permeated by membrane separation with the third membrane separator;
a third non-permeate gas discharge line configured to discharge a third non-permeate gas not permeated by membrane separation with the third membrane separator and supply the third non-permeate gas to the combustion gas discharge line; and
a second vacuum pump provided in a middle of the third permeate gas discharge line.

3. The carbon dioxide separation device according to claim 1, wherein in a case where a carbon monoxide concentration downstream of the combustor is a predetermined value or lower and an oxygen concentration upstream of the combustor is lower than a predetermined value, a pressure of the combustion gas that is supplied to the second membrane separator is decreased with the compressor.

4. The carbon dioxide separation device according to claim 1, wherein in a case where an oxygen concentration upstream of the combustor is a predetermined value or higher, a pressure of the combustion gas that is supplied to the second membrane separator is increased with the compressor.
